(19) United States
(12) Patent Application Publication
(10) Pub. No.: US 2010/0280989 A1
(43) Pub. Date: Nov. 4, 2010

(54) ONTOLOGY CREATION BY REFERENCE TO A KNOWLEDGE CORPUS

(76) Inventors: Pankaj Mehra, San Jose, CA (US); Roger Brooks, Palo Alto, CA (US); Christopher Thomas, Dayton, OH (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/432,492

(22) Filed: Apr. 29, 2009

(51) Int. Cl. G06N 5/02; G06F 17/30

(52) U.S. Cl. 706/59; 707/E17.005; 707/E17.014; 707/E17.045

(57) ABSTRACT

A computer-implemented method and computer readable media for creating an ontology for a domain by reference to a knowledge corpus comprising linked documents and a category hierarchy wherein each document can be contained in one or more categories and wherein categories can contain one or more other categories. In some embodiments, the method comprises: searching the corpus to identify documents with text that matches a seed domain description; identifying further documents within the corpus that are semantically similar to the identified documents; identifying a subgraph of the category hierarchy that includes the categories assigned to the extracted documents and the further documents; reducing the subgraph to form the ontology by requiring that documents therein be indicative of a second domain description, the second domain description being at least as broad as the seed domain description.

### BACKGROUND

The average knowledge worker spends approximately 25% of their time searching for information relevant to their task at hand. Tools for automatically organizing knowledge are thus not only important to improving employee productivity, but also useful for both automated enforcement of compliance policies and information risk management. Using sophisticated knowledge-management tools, information can become an organizational asset. To this end, organizations have been building taxonomies or more generally ontologies, which systematically arrange the concepts underlying their knowledge domains into category hierarchies.

### BRIEF DESCRIPTION OF THE DRAWINGS

Embodiments of the invention will now be described by way of example only with reference to the accompanying drawings, wherein:

FIG. 1 illustrates an apparatus for creating an ontology in embodiments of the invention;

FIG. 2 illustrates a computer-implemented method for creating an ontology in embodiments of the invention.

### DETAILED DESCRIPTION

Embodiments of this invention concern computer-implemented methods for automatically creating an ontology comprising a graph representing a hierarchy of related concepts. In typical workflows, the concepts may, for instance, be made available for examination by a librarian or other domain specialist on the one hand, and may also be usable by applications such as automatic classifiers or taggers, on the other. For the former, taxonomy specialists may use standard tools of the trade, such as the Protégé ontology editor, which may require the concepts to be organized and presented according to industry-standard formats, such as OWL, where they can be interactively manipulated and examined by experts using query languages such as SPARQL. For the latter, automated classifiers using Naïve Bayes or other model-driven classification algorithms for example, may also require numerical information such as domain prior and conditional probabilities.

The ontology can take many forms, but in the described embodiments the ontology would be expressed in the form of a standard OWL code comprising a formal description of membership for each category within a taxonomy. Given such a description, classifiers for instance may be able to map text objects into categories simply by determining the degree to which the various terms appearing in these objects can be deemed as relevant to one or more of the categories. Such classification could either be manual or machine-based.

Wikipedia is a large and growing public knowledge base comprising several million articles. It is a community resource in which content is authored and maintained by a community of volunteer members. Wikipedia's structure consists of a topic name, which is unique and thus suitable for a concept name, and links connecting articles, which may be indicative of semantic relations between them.

The MediaWiki software, which Wikipedia uses, allows pages and files to be categorized by appending one or more Category tags to the content text. Adding these tags creates links at the bottom of the page that link to the list of all pages in that category, which makes it easy to browse related articles. A category is a software feature of the MediaWiki software. Categories provide automatic indexes that are useful as tables of contents.

In the present Wikipedia corpus, there are a very large number of human-edited links that refer from topic to topic, from topic to category, and from category to sub- or super-categories. There are hundreds of thousands of categories.

In this disclosure, an ontology is created by leveraging the human-created categories found in the Wikipedia corpus. Use is made of the linkages between Wikipedia topics, assigned by the authors of that corpus in the form of hyperlinks between the topics and categories within the corpus.

More particularly, Wikipedia's link graphs and category hierarchy are mined for topics that are domain-relevant. These topics are then used as terms in the generated ontologies. The terms inherit Wikipedia's category hierarchy and, consequently, the human knowledge base underlying that hierarchy.

In the embodiments described herein, Wikipedia is used as a convenient knowledge corpus for ontology creation. However, it will be understood that other similar or comparable knowledge corpuses that comprise linked documents and a category hierarchy that is such that each document can be contained in one or more categories and categories can contain one or more other categories may equally be used with the techniques described. These may be public, private or industry or enterprise-specific information sources, for instance.

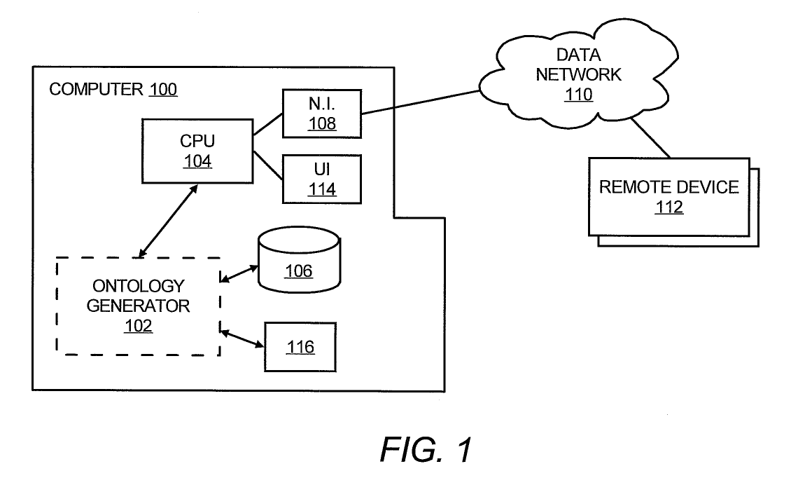

Referring now to FIG. 1, there is shown an apparatus for creating an ontology. The apparatus of FIG. 1 comprises a computer 100 in which ontology generator software 102 is executable. The ontology generator software 102 is executable on one or more central processing units 104. The ontology generator is linked to a knowledge corpus illustrated at 106 which is stored in one or more suitable data structures in a storage device e.g., non-persistent memory (such as dynamic random access memories) or persistent storage (such as a disk storage medium). In the described embodiments, knowledge corpus 106 is assumed to be the Wikipedia corpus or a copy thereof.

Also shown in FIG. 1 is that the computer 100 may comprise network interface 108 enabling computer 100 to communicate with one or more remote devices 112 via data network 110. In particular, the knowledge corpus 106 may be stored in some embodiments on one or more remote devices 112 instead of or in addition to being stored in computer 100.

Computer 100 may also comprise a suitable user interface 114 for enabling a human user to interact with computer 100 to receive information and enter commands and queries, for instance.

Ontology generator software 102 serves to generate an ontology illustrated at 116 in FIG. 1 in a suitable encoded form such as OWL code.

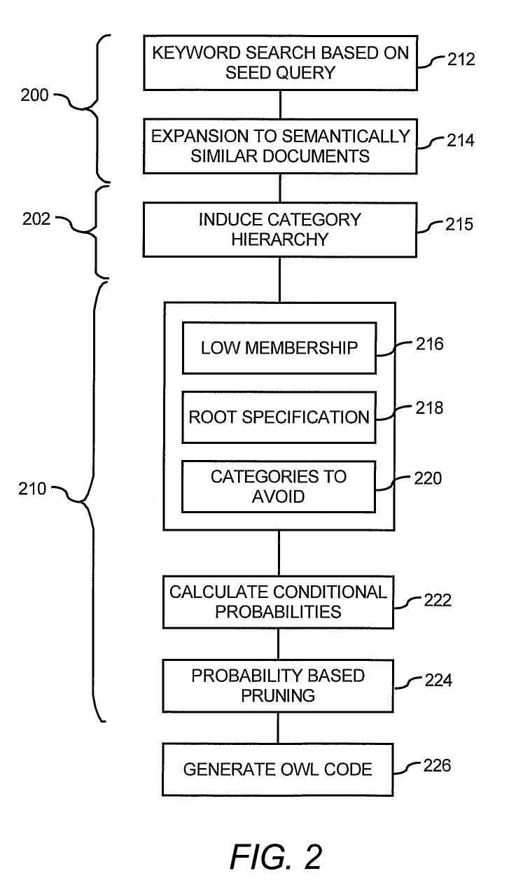

FIG. 2 illustrates a method employed by ontology generator software in embodiments of the invention. As shown in FIG. 2, the method proceeds in 3 main phases: an expansion phase 200, category structure extraction 202 and a reduction phase 210.

Expansion phase 200 takes as input a Boolean seed query and in step 212 a keyword search is carried out in knowledge corpus 106 to identify topics that serve as candidate concepts according to the seed query. Many full text search engines are available and any suitable full text search method can be used that returns a ranked list of topics. The seed query may in some embodiments be entered by a user via user interface 114.

The quality of the candidate concepts retrieved in step 212 may vary. For instance, if the user was interested in saving for college, they might provide a Boolean seed query such as:

+account AND (higher education tuition college student) AND (“tax deductible” coverdell 529 saving savings)

Depending on how many results are retained and due to the nature of keyword matching, one of the concepts retrieved might be an article concerning the US Senator “Paul Coverdell” which is not relevant to the user's underlying interest. Moreover, certain concepts that may be highly relevant to the users underlying interest, such as “gift tax”, might be overlooked by the initial keyword match. As is commonly the case with keyword searching, the signal-to-noise ratio drops rapidly as lower-ranked results are considered.

In consequence, a user-controlled set number of initial keyword search results are retained from the content search after step 212, and then the method switches over to a link-based relatedness technique in step 214 that expands the results to include semantically similar documents. The method used in step 214 in some embodiments employs a modified version of Dice's coefficient to measure the level of relatedness between 2 topics within the Wikipedia corpus. Dice's coefficient is a similarity measure that is commonly used in information retrieval, which means in the case of Wikipedia articles that two articles will be related if the ratio of the links they have in common to the total number of links of both pages is high. Since Wikipedia uses different classes of links which reflect greater or lesser degrees of relatedness, a weighting scheme is used based on the link type with, for instance “See also” links being highly weighted and regular links being not so highly weighted.

In some embodiments, the method exploits the short diameter and high link quality of Wikipedia to apply only one iteration of spreading on the basis that in the Wikipedia corpus whichever concepts should be linked are probably already directly linked. In some embodiments, a Dice matrix containing weighted Dice similarity coefficients for pairs of Wikipedia topics may be prepared in advance.

The method takes a topic title as input and returns a weighted list of titles that are most similar. Accidentally discovered unrelated concepts are removed from the results by applying a weighted-aggregated relevance of a discovered concept, c,

$$NetRelevanceFromRecall ( c ) = {\sum }_{p} {w}_{1} ( c , p ) {w}_{2} ( c , p )$$

where p ranges over all paths leading from seed query to c, w₁ is the relevance weight returned by the keyword search using the seed query i.e., step 212, and w₂ is a modified Dice similarity weight returned by link-based expansion of step 214.

This algorithm causes a discovered secondary concept, such as gift tax, to first incur the penalty of indirect discovery, by multiplying sub-unit quantities, but then accrue authority by summing across multiple ways of reaching the same secondary concept from multiple primary concepts.

Depending on the seed query, hundreds, if not thousands, of concepts may nevertheless emerge from the identification steps 212 and 214 described above in the expansion phase 200.

As noted above, Wikipedia has a rich category structure that is mostly human generated. Category-structure extraction 202 starts by inducing the Wikipedia category subgraph in step 215 using the concepts discovered using the identification steps described above. However, this graph may not itself be either very presentable or very useful because of the cyclical and multiple-inheritance structure of Wikipedia concepts and categories.

Two classes of algorithms are used to arrive at more presentable organizations of concepts by pruning during the reduction phase 210.

First, the weights and probabilities of covered concepts derived from the identification steps are used to determine the weights of categories and in turn super-categories by simple summation. Categories with low membership are pruned in step 216, potentially causing parent categories to be pruned in turn.

Second, users can restrict category inference to a list of Wikipedia category subtrees by specifying a list of roots in step 218, such as education_finance; internal_revenue_code; personal_life (for the example described above) that represent their world view or perspective. Categories that do not link to these roots are removed. Likewise, the user may specify a categories-to-avoid list in step 220 and categories that link to these categories are also pruned. In some embodiments these root nodes and categories may be presented to the user via user interface 114 and the user may be enabled to select those roots to include and those categories to avoid.

The forest of resulting subtrees is then topologically sorted to create a hierarchy of preferred categories.

The expansion phase 200 is mostly recall-driven. In order to assure precision, the number of terms and categories that were expanded and created are reduced to a subset that matches a broader focus domain.

The key input into this precision-oriented process is a second Boolean “domain query” that is at least as broad as and may be broader than the seed query, such as the following (continuing the above example):

(coverdell 529 “education IRA” college tuition higher education student) AND (cost tax deduct* money saving savings account “financial aid”)

The subgraph is reduced by requiring that documents therein be indicative of the second domain description as described below. The domain query may be generated by enabling the user to select representative topics or categories that are uncovered using the seed query via user interface 114.

The domain query acts as a pruning mechanism to check if the nodes reached through aggressive recall appear to have content that mentions at least one of the several general concepts of the broader domain of interest.

For each expanded term t remaining after steps 216, 218 and 220, the conditional probability of the term belonging to the domain is computed as:

$$Pr ( t \vert C ) = {\sum }_{C ⋂ t} {score}_{t} / {\sum }_{C} {score}_{C}$$

And, for each expanded term t that remains after the pruning steps 216 218 and 220, the conditional probability of it being indicative of the domain is calculated:

$$Pr ( C \vert t ) = {\sum }_{C ⋂ t} {score}_{t} / {\sum }_{t} {score}_{t}$$

Where scoreₜ is the score of the term that resulted from the full text keyword search 212 based on the seed query and score_{c} is the score of each element returned by a full text search using the domain query. These conditional probabilities are calculated in step 222 of FIG. 2.

For step 224, thresholds are defined that indicates how relevant a term has to be to the domain of interest in order for it to be taken into consideration in the final ontology. In some embodiments the terms are presented to the user together with these conditional probabilities and the user is enabled to set separate thresholds. Terms with conditional probabilities below the thresholds are removed, potentially causing parent categories to be pruned in turn.

The final OWL code is generated in step 226.

In summary, there has been described a program for building conceptual models of information domains. It produces concept-rich OWL ontologies starting from simple domain descriptions, i.e., the seed queries and domain queries. In addition to mining Wikipedia's topic space, the category structure and graph structure are also exploited, and separate relevancy statistics are computed for domain-specific subspaces.

The typical user may be able to hone in on a good pair of seed and domain queries using a small number of iterations using the above approach. Once set, the seed-domain pair can be repeatedly and automatically refreshed against newer corpus content.

Any or all of the tasks described above may be provided in the context of information technology (IT) services offered by one organization to another organization. For example, the computer 100 (FIG. 1) may be owned by a first organization. The IT services may be offered as part of an IT services contract, for example.

Instructions of software described above (including ontology generator software 102 of FIG. 1) are loaded for execution on a processor (such as one or more CPUs 104 in FIG. 1). The processor includes microprocessors, microcontrollers, processor modules or subsystems (including one or more microprocessors or microcontrollers), or other control or computing devices. As used here, a “processor” can refer to a single component or to plural components.

Data and instructions (of the software) are stored in respective storage devices, which are implemented as one or more computer-readable or computer usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

1. A computer-implemented method for creating an ontology for a domain by reference to a knowledge corpus comprising linked documents and a category hierarchy wherein each document can be contained in one or more categories and wherein categories can contain one or more other categories, the method comprising:
searching the corpus to identify documents with text that matches a seed domain description;
identifying further documents within the corpus that are semantically similar to the identified documents;
identifying a subgraph of the category hierarchy that includes the categories assigned to the extracted documents and the further documents;
reducing the subgraph to form the ontology by requiring that documents therein be indicative of a second domain description, the second domain description being at least as broad as the seed domain description.

2. A computer-implemented method as claimed in claim 1 wherein the identification of the semantically similar further documents comprises scoring links between the documents using a relative weighting scheme according to link type.

3. A computer-implemented method as claimed in claim 1 wherein the searching step provides a score for each identified document and wherein a threshold is applied to the search score to identify the documents.

4. A computer-implemented method as claimed in claim 3 comprising calculating conditional probabilities from the scores.

5. A computer-implemented method as claimed in claim 1 wherein the knowledge corpus is a wiki.

6. A computer-implemented method as claimed in claim 1 wherein the wiki is maintained by a community that can create the categories, documents and links.

7. A computer-implemented method as claimed in claim 1 wherein the reducing step comprises removing categories with low membership.

8. A computer-implemented method as claimed in claim 1 wherein the reducing step comprises removing one or more user specified root categories.

9. A computer-implemented method as claimed in claim 4 wherein a first conditional probability of a term being indicative of the second domain description is computed as:
$$Pr ( t \vert C ) = {\sum }_{C ⋂ t} {score}_{t} / {\sum }_{C} {score}_{C} ,$$
and the subgraph is reduced by removing terms with a low first conditional probability.

10. A computer-implemented method as claimed in claim 4 wherein a second conditional probability of the second domain contains a term is computed as:
$$Pr ( C \vert t ) = {\sum }_{C ⋂ t} {score}_{t} / {\sum }_{t} {score}_{t}$$
and the subgraph is reduced by removing terms with a low second conditional probability.

11. A computer readable media comprising program code elements executable by a processor for creating an ontology for a domain by reference to a knowledge corpus comprising linked documents and a category hierarchy wherein each document can be contained in one or more categories and wherein categories can contain one or more other categories, the elements when executed implement a method comprising:
searching the corpus to identify documents with text that matches a seed domain description;
identifying further documents within the corpus that are semantically similar to the identified documents;
identifying a subgraph of the category hierarchy that includes the categories assigned to the extracted documents and the further documents;
reducing the subgraph to form the ontology by requiring that documents therein be indicative of a second domain description, the second domain description being at least as broad as the seed domain description.

12. A computer readable media as claimed in claim 11 wherein the identification of the semantically similar further documents comprises scoring links between the documents using a relative weighting scheme according to link type.

13. A computer readable media as claimed in claim 11 wherein the reducing step comprises removing one or more user specified root categories.

14. A computer readable media as claimed in claim 11 comprising computing a first conditional probability of a term being indicative of the second domain description as:
$$Pr ( t \vert C ) = {\sum }_{C ⋂ t} {score}_{t} / {\sum }_{C} {score}_{C} ,$$
and the subgraph is reduced by removing terms with a low first conditional probability.

15. A computer readable media as claimed in claim 11 comprising computing a second conditional probability of a term being indicative of the second domain description as:
$$Pr ( C \vert t ) = {\sum }_{C ⋂ t} {score}_{t} / {\sum }_{t} {score}_{t}$$
and the subgraph is reduced by removing terms with a low second conditional probability.
